(19) United States
(12) Patent Application Publication
(10) Pub. No.: US 2008/0230367 A1
(43) Pub. Date: Sep. 25, 2008

(54) Water Distillation Device

(76) Inventor: Stuart Robert Cannon, Vic (AU)

Correspondence Address: THOMAS, KAYDEN, HORSTEMEYER & RISLEY, LLP, 600 GALLERIA PARKWAY, S.E., STE 1500, ATLANTA, GA, 30339-5994, US

(21) Appl. No.: 12/064,865

(22) PCT Filed: Aug. 25, 2006
(86) PCT No.: PCT/AU2006/001222

§ 371 Date: Feb. 26, 2008

(30) Foreign Application Priority Data
Sep. 2, 2005 (AU) 2005904813

(51) Int. Cl. C02F 1/14

(52) U.S. Cl. 202/234

(57) ABSTRACT

A means for collecting distilled water is disclosed which comprises a distillation cell or an array of such cells each cell comprising taut transparent sheets arranged around a collection point for such distilled water and means for collecting such distilled water.

### BACKGROUND OF THE INVENTION

The concept of distillation is as old as Archimedes who first mentioned the possibilities in notes. The applicant has been building fabric tension structures for shelter from the effect of weather etc. for 25 years. These structures may cover areas of up to 5 hectares. They have been used in many countries, for example, USA, India, the Middle East, Indonesia, for many purposes including car and aircraft storage and plant nurseries. Over the last five years they have been used to cover town water dams to remove algal blooms and to cut evaporation. (The covers block bird droppings and UV light and also minimize the need for chemical additives). It became apparent that even when using cloth, which is not at all suited to collecting condensation over dams, large amounts of distilled water were collected.

### THE PRESENT INVENTION

This invention provides a distillation cell which comprises tensioned transparent sheets forming a shallow box-like structure provided with internally sloping V-shaped roof segments or panels wherein moist air, liquid, slurry or moist solid may be passed into the cell and water condenses on the lower surface of the V-shaped roof segments and may be passed to collection.

The cells according to the invention may be arranged linearly or in arrays.

Preferably means are supplied to introduce a stream of raw liquid or slurry into the bottom of the space from which water may be distilled.

In one embodiment the distillation cell according to the invention comprises a structure of tensioned fabric laminated to a transparent sheet or sheets. In one embodiment the distillation cell produces 1 cubic metre (1000 litres) of water per annum per square metre.

While the general thrust of distillation devices has been to improve efficiency—to get maximum water from least space—this is not necessary with the structure according to the invention. Instead the applicant has opted for the least expensive structure to produce the most water. As Australia does not have a serious space problem this seems logical.

It will take slightly more space to produce a set quantity of water but the invention can achieve this object less expensively than other methods.

The structure described in this specification is modular and multiple structures can be connected with similar structures to cover very large areas.

A hectare of the applicant's structures would produce about 10 megalitres per year. In all cases rain water can be collected as well as the condensate and kept separate or mixed as desired.

The applicant provides evenly stressed panels to form the distillation structure. The material of the roof of the structure may be shadecloth with a layer of clear film laminated to it to provide airtightness and waterproofing. However, it is preferably made of clear film by itself or any other robust fabric or film which gives good light and heat transparency. The roof panels droop to the centre to cause condensation on the inner roof of the structure to run to the centre and be collected in a circular tray and sent down a pipe.

Preferably, in order to commence condensation, a supply of slightly warmed water is used. A solar pump running water through coils of small diameter polyethylene pipe suffices.

A black floor is sufficient to create condensation.

The structure according to the invention requires a material that transmits light and warmth. It also requires a differential between the inside temperature and the temperature outside which is why a fully enclosed structure is most efficient. Any structure containing water will produce vapour. Such structures work best at dusk and dawn, if the contents are warm. The ambient temperature must not exceed 65° C. as the plastics materials used start to affect the water distilled. However, it is these modern materials combined with the designs and techniques developed by the Applicant that make this structure viable. There are many methods of keeping the temperature controlled, including ventilation, the use of shadecloth and the height of the structure.

### APPLICATIONS OF THE PRESENT INVENTION

Salt affected land: A solar pump can be used to raise salt water from below the surface. Thus, salt water is run through the structure of the present invention and the salt and the distilled water collected separately. The salt production is not worth much, probably enough to pay for its removal. This means that the water would cost around A$1500 to A$2000 per megalitre. While this cost is slightly high for irrigation it is not for potable water.

Polluted water: Any kind of water (except for some more exotic forms of polluted water) can be fed into the structure of the present invention. Dam water, effluent, grey water or salt water can all be used. Thus water can be reclaimed from rivers, oceans, dams, overflow containers or sewage.

Production of distilled water from sea water: A structure can be built over salt water and distilled water harvested. This would not be as productive as an enclosed land-based system but in the case of coastal cities such as Adelaide or Perth it would not matter if the efficiency was lower as space would not be a problem and the low cost per square metre would make ii attractive.

The structure according to the invention could be built over dams thus collecting water which is currently lost to evaporation. In the case of small town water storage such a structure could provide the water for a town without the need for chlorination plants and the associated chemicals. Thus the structure would become the purification plant allowing a dam to be used until it was completely empty. At the moment turbidity prevents the use of more than 80% of a dam.

It is acknowledged that distilled water is too pure and may in some cases need additives to prevent salt losses in humans. It is easy to add salt if required. Running water over marble chips is a more natural way of adding salts than directly adding salts but the result is the same.

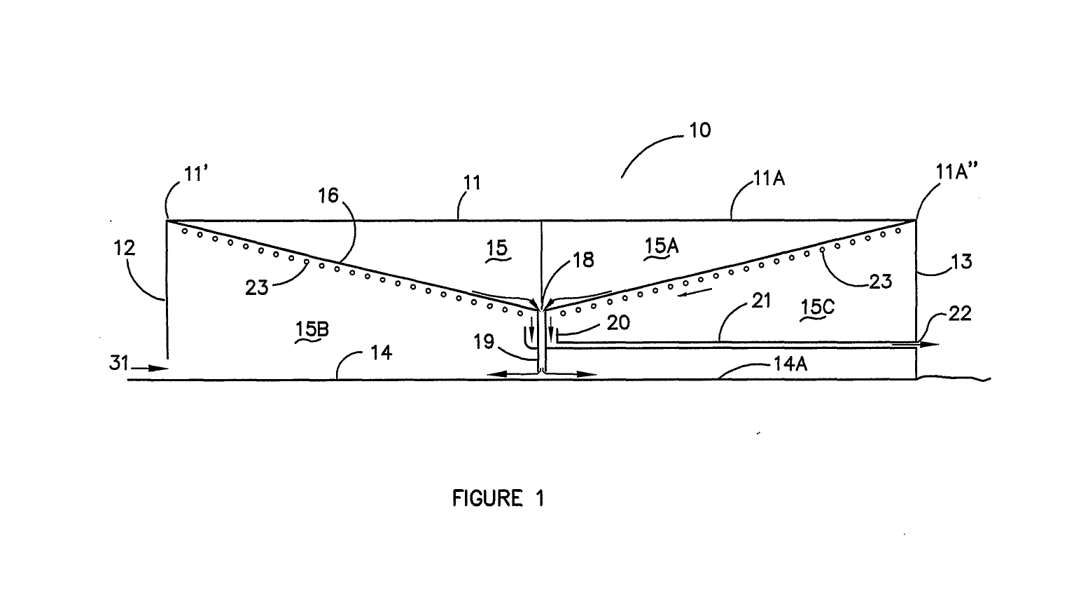

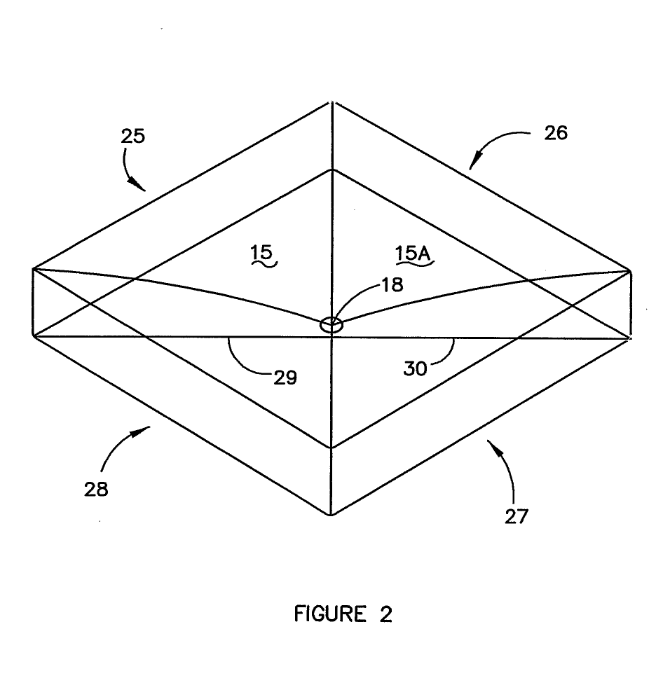

FIGS. 1 and 2 relate to a single cell example according to the invention.

Turning to Example 1: FIG. 1 is a cross-section of a square distillation cell. Thus integer 10 refers to the cell as a whole and integers 11 and 11A to the upper edges of two faces respectively. Integer 12 refers to a left hand vertical face of the cell and integer 13 to a right hand vertical face. Integers 14 and 14A refer to lower, interior surfaces of the cell corresponding to faces 11 and 11A respectively. Integers 15 and 15A refer to shallow triangular faces appended to upper edges 11 and 11A respectively.

Integer 16 refers to a downwardly sloping element stretching from upper edge 11′, which is at a right angle to upper edge 11.

Integers 15B and 15C refer to lower interior faces appended to elements 16 and 17 respectively and integers 12 and 13 respectively and lower, interior surfaces 14 and 14A respectively, thus completing distillation cell portions 15B and 15C.

A corresponding element 17 slopes downwardly from corresponding edge 11A″ at the other side of the cell which is at a right angle to side 11A.

A fourth and a fifth, sloping surfaces above the page are not shown in FIG. 1. but can be comprehended from FIG. 2.

The four sloping surfaces intersect at hole 18 which leads into downwardly extending pipe 19. A bowl 20 surrounds the upper portion of pipe 19 which extends downwardly into pipe 21 which empties through hole 22. Integer 23 refers to condensation on the bottom of the sloping elements 16 and 17. This condensation (distilled water) falls into bowl 20, proceeds through pipe 21 and out through hole 22.

Rain (see integer 24) falling into the top of the cell proceeds through hole 18 down pipe 19 over lower surfaces 14 and 14A of the cells. The rain water may be collected separately from pipe 19 and used separately or distilled.

Integer 31 refers to an entry point for rain water or sea water, turbid dam water etc which may then be distilled, caught in bowl 20 etc.

Turning to FIG. 2., integers 25, 26, 27 and 28 refer to corresponding sides of cell 10. Integer 29 refers to a pipe leading rain water to the bottom of the cell from which it can be distilled and integer 30 to a pipe leading distilled water to a central collecting point. Thus the two feeds may be collected separately or the rain water may be distilled and the two feeds combined.

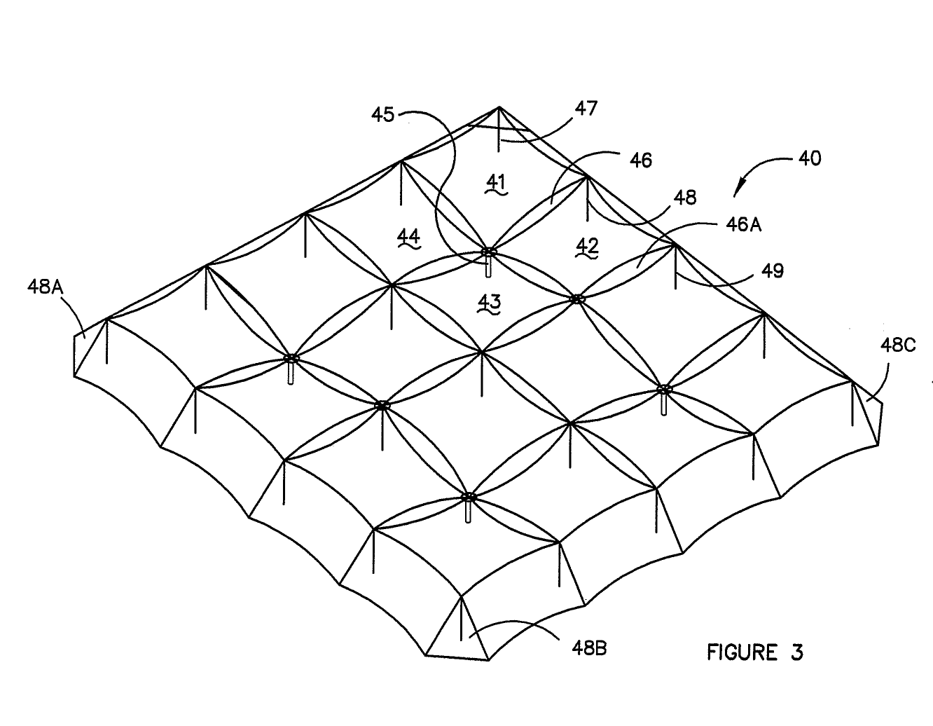

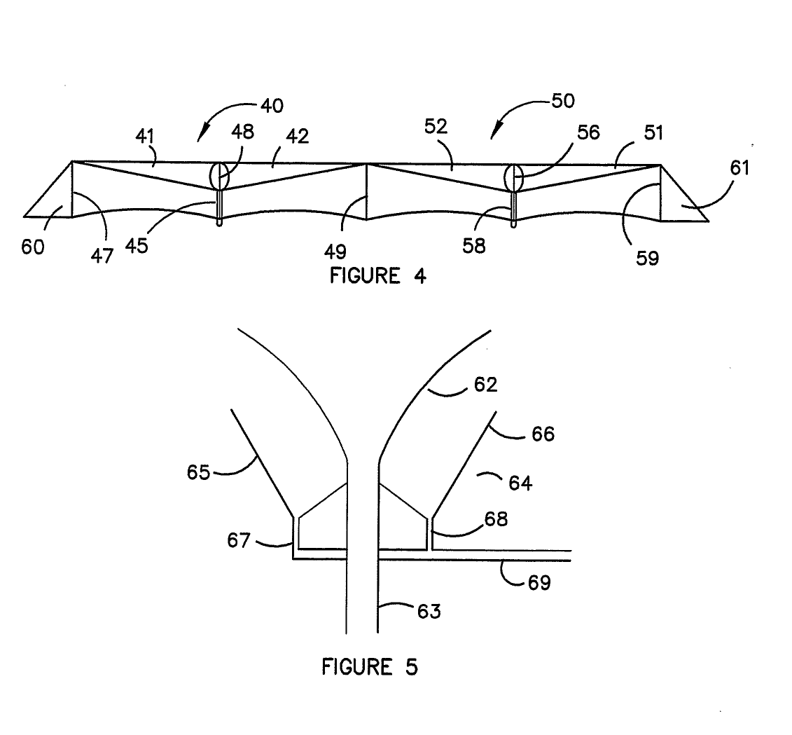

FIGS. 3 and 4 relate to a perspective view of an array of the single cells according to FIGS. 1 and 2 and to a cross-section of this array respectively.

Cell 40 is made up of four shallow sloping surfaces 41, 42, 43 and 44 meeting together at the top of drainage tube 45. Numeral 46 indicates a lens-shaped join between sloping surfaces 41 and 42. (Four internal joins 46 are shown and four external joins 46A for each cell, the four external joins being shared with neighbouring cells). Numeral 47 indicates a support post, one of twenty-one in the array. Numerals 48A, 48B and 48C indicate three of four corner external elements in the array.

FIG. 4 illustrates a partial view/cross-section across two cells, the left cell being the one illustrated in FIG. 3. Thus, numeral 50 indicates the right cell.

Two sloping surfaces 51 and 52 in the right hand cell are seen. Numerals 45 and 58 indicate drainage tubes. Numerals 47, 48, 49, 56 and 59 indicate support posts. Numerals 60 and 61 indicate corner elements.

FIG. 5 illustrates a collection point for rain water and distilled water. Thus numeral 62 indicates a wide neck funnel ending in pipe 63. Arranged around pipe 63 is a plurality of collection funnels 64, illustrated by funnels 65 and 66. (Alternatively a single concentric funnel may be used). Distilled water is led away by pipes 67 and 68 to takeaway pipe 69. (Again, if a concentric funnel is used one pipe only may be used to lead the distilled water to the takeaway pipe 69).

An array of the cells illustrated may be constructed, for example, one covering a dam or one near an estuary.

What is claimed is:

1. A distillation cell which comprises tensioned transparent sheets forming a shallow box-like structure provided with internally sloping V-shaped roof segments or panels, wherein moist air, liquid, slurry or moist solid may be passed into the cell and water condenses on the lower surface of the V-shaped roof segments and may be passed to collection, and which cell is further provided with a central collecting point for rainwater adjacent the collection point for condensed water.

2. A distillation cell as claimed in claim 1 wherein the cell is constructed of tensioned fabric laminated to a transparent sheet or sheets.

3. A distillation apparatus which comprises distillation cells as claimed in claim 1 arranged linearly.

4. A distillation apparatus which comprises distillation cells as claimed in claim 1 arranged in arrays.

5. (canceled)
